(19) United States
(12) Patent Application Publication
(10) Pub. No.: US 2013/0077320 A1
(43) Pub. Date: Mar. 28, 2013

(54) OPTICAL LENS AND ILLUMINANT DEVICE USING THE SAME

(71) Applicants: Qiang-Fei DUAN, New Taipei City (TW); Mao-Sheng Liang, New Taipei City (TW)

(72) Inventors: Qiang-Fei DUAN, New Taipei City (TW); Mao-Sheng Liang, New Taipei City (TW)

(73) Assignee: COOLER MASTER CO., LTD.

(21) Appl. No.: 13/244,268

(22) Filed: Sep. 23, 2011

(51) Int. Cl. F21V 13/04

(52) U.S. Cl. 362/297; 362/327; 362/309

(57) ABSTRACT

An optical lens having an optical axis includes a main body. The main body includes a light-incident part, a first light-emitting part and a second light-emitting part. The light-incident part includes a bottom surface and a reflecting surface. The bottom surface has a recess. The reflecting surface is physically connected to the bottom surface and the distance located between the reflecting surface and the optical axis is increased when the reflecting surface is gradually close to the bottom surface. The first light emitting-part is physically connected to the reflecting surface and has a top surface. The top surface is gradually close to the bottom surface when the top surface is close to the optical axis. The second light-emitting surface is physically connected to the top surface and substantially located above the recess.

### BACKGROUND OF THE INVENTION

1. Field of the Invention

The present invention relates to an optical lens, and in particular to an optical lens having a reflecting surface for allowing light reflecting thereon with a condition of total internal reflection.

2. Description of Prior Art

Light emitting diodes (LEDs) have the advantages of small volume, long lifetime, difficulty damage, without mercury and lower power consumption. They are gradually replacing the fluorescent tubes and incandescent lamps and widely used in indoor or outdoor lighting and decorative lighting.

In order to improve lighting distance and the illuminative effect of the lamp having LEDs, the conventional LED lamp includes a reflecting element and an optical lens. The reflecting element may be made of metal material and have poculiform profile or made of plastic material and coat with a metallic reflecting-film to achieve the effect of light-reflection. The optical lens is engaged with a front end of the reflecting element and covered LEDs. The optical lens may be made of light permeable material, such as glass or resin, and can be convex, concave or Fresnel lens according to light fields. The light emitted from the LEDs is passing through the optical lens and generates luminous intensity distribution of requirement.

To improve the illumination of the LED lamp to be more close to the illumination of the incandescent lamp, the power of the LEDs must be improved, however, the heat produced by the LEDs is also increased during the LEDs are operation.

Because the material of the reflecting element and the optical lens are different, the coefficients of thermal expansion of both are different. When the LEDs operation for a long time, the heat produced by the LEDs make the reflecting element and the optical lens to deform and reduce the tightness of seal such that the optical lens may fall out and influence the lighting effect of the LED lamp.

### SUMMARY OF THE INVENTION

It is an object of the present invention to provide and optical lens, the optical lens has a reflecting surface. The reflecting surface reflects light traveling thereon with a condition of total internal reflection and changes the light propagation route and emitting light from a first light-emitting part.

Accordingly, the present invention provides an optical lens having an optical axis. The optical lens includes a main body. The main body includes a light-incident part, a first light-emitting part and a second light-emitting part. The light-incident part includes a bottom surface and a reflecting surface, the bottom surface has a recess, the reflecting surface is physically connected to the bottom surface and the distance located between the reflecting surface and the optical axis is increased when the reflecting surface is gradually far away from the bottom surface. The first light-emitting part is physically connected to the reflecting surface and has a top surface, the top surface is gradually close to the bottom surface when the top surface is gradually close to the optical axis. The second light-emitting part is physically connected to the top surface and substantially located above the recess.

The present invention further provides an illuminant device. The illuminant device includes a housing, an illuminant unit, an optical lens and a conductive connector. The housing has a circumferential wall, the circumferential wall formed an accommodating recess. The illuminant unit is disposed on the accommodating recess and including a circuit board and at least a light emitting diode (LED) mounted on the circuit board. The optical lens having an optical axis includes a main body. The main body includes a light-incident part, a first light-emitting part and a second light-emitting part. The light-incident part includes a bottom surface and a reflecting surface. The bottom surface has a recess and the LED is disposed on the recess. The reflecting surface is physically connected to the bottom surface and the distance located between the reflecting surface and the optical axis is increased when the reflecting surface is far away from the bottom surface. The first light-emitting part is physically connected to the reflecting surface and having a top surface, the top surface is gradually close to the bottom surface when the top surface is gradually close to the optical axis. The second light-emitting part is physically connected to the top surface and substantially located above the recess. The conductive connector is engaged with one side of the housing where opposite to the optical lens is disposed.

The main body of the optical lens of the present invention has reflecting surface can directly change the travelling route of light so as to emit light by the first light-emitting part, and the first light-emitting part is designed to be stepwise can effectively reduce the transmission distance of light travelling in the main body to reduce losses of light travelling in the main body and simultaneously reduce volume and weight of the optical lens.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is an exploded view of an illuminant device according to a first preferred embodiment of the present invention.

FIG. 2 is an assembly view of the illuminant device according to the first preferred embodiment of the present invention.

FIG. 3 is a partially sectional view of the illuminant device according to the first preferred embodiment of the present invention.

FIG. 4 is a sectional view of an optical lens according to a first preferred embodiment of the present invention and shows ray tracing thereof.

FIG. 5 is a schematic view of the luminous intensity distribution.

FIG. 6(a) is a diagrammatic representation of light refraction and reflection.

FIG. 6(b) is a diagrammatic representation of total internal reflection.

FIG. 7 is a sectional view of an optical lens according to a second preferred embodiment of the present invention and shows ray tracing thereof.

FIG. 8 is a sectional view of an optical lens according to a third preferred embodiment of the present invention and shows ray tracing thereof.

FIG. 9 is a sectional view of and optical lens according to a fourth preferred embodiment of the present invention.

FIG. 10 is an assembly view of an illuminant device according to a second preferred embodiment of the present invention.

FIG. 11 is a perspective view of an illuminant device according to a third preferred embodiment of the preferred invention.

FIG. 12 is a sectional view of the illuminant device according to the third preferred embodiment of the present invention.

FIG. 13 is an exploded view of an illuminant device according to a fourth preferred embodiment of the present invention.

FIG. 14 is a sectional view of the illuminant device according to the fourth preferred embodiment of the present invention.

### DETAILED DESCRIPTION OF THE INVENTION

Reference will now be made in detail to the present embodiments of the invention, examples of which are illustrated in the accompanying drawings. Wherever possible, the same reference numbers are used in the drawings and the description to refer to the same or like parts.

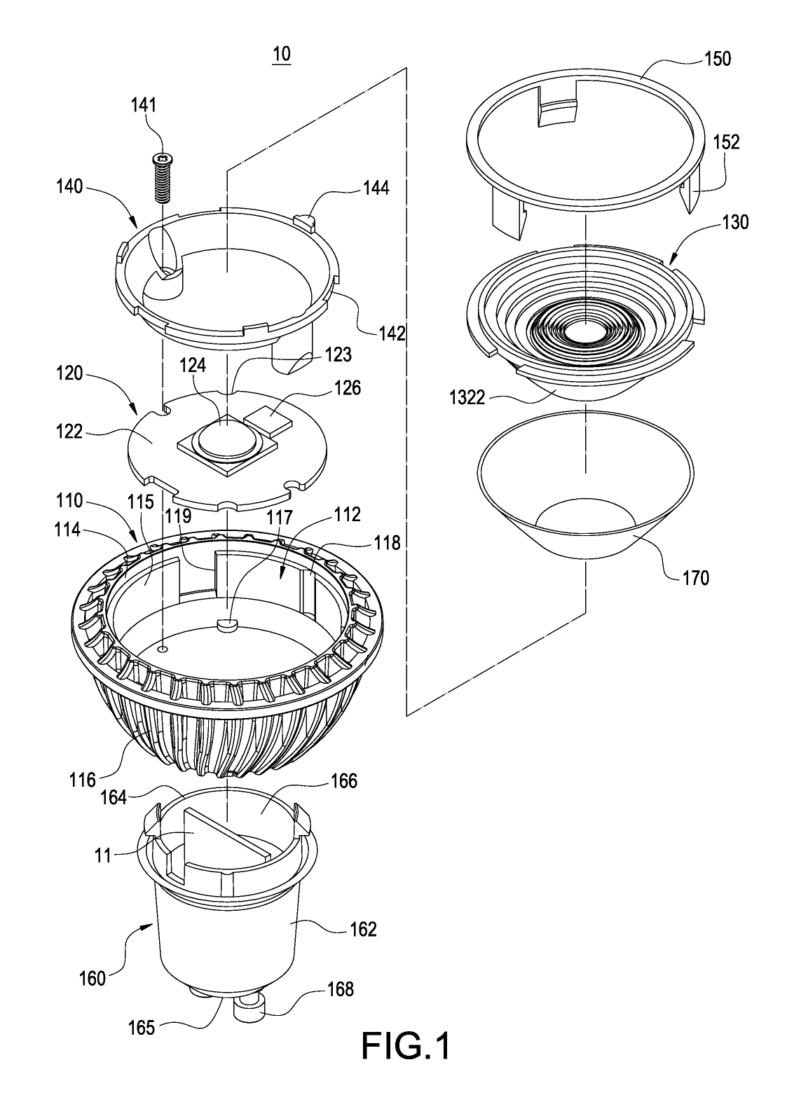

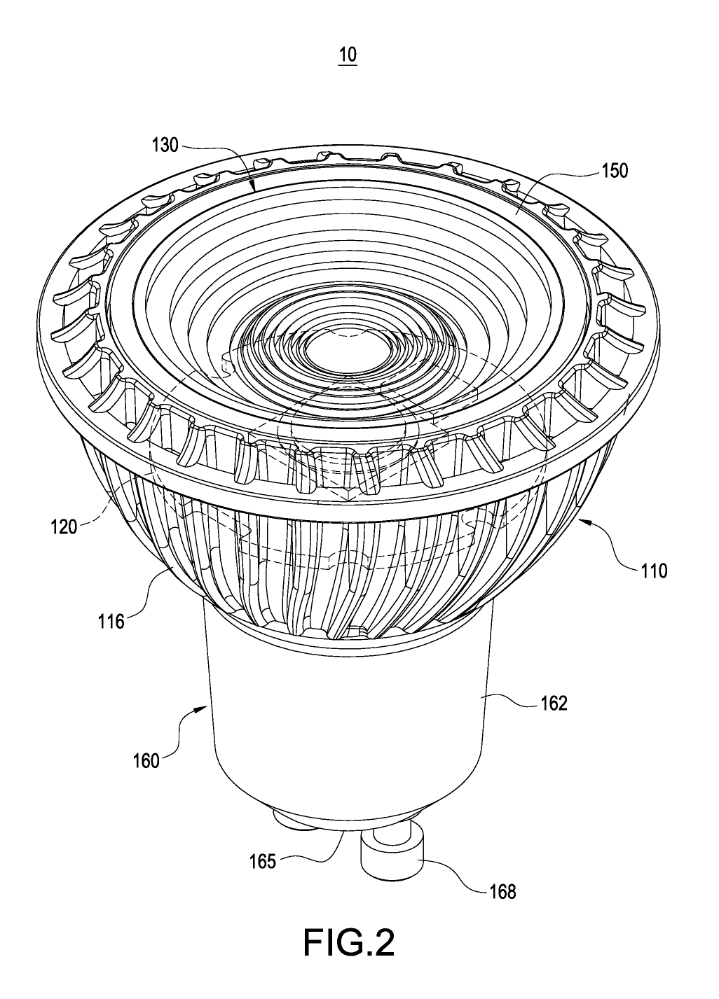

Reference is made to FIG. 1 and FIG. 2, which are respectively an exploded view and an assembled view of an illuminant device according to a first preferred embodiment of the present invention. The illuminant device 10 includes a housing 110, an illuminant unit 120, an optical lens 130, a supporting element 140, a wedging element 150 and a conductive connector 160.

The housing 110 is made of metal material, such as aluminum, and has a substantially poculiform (cup-shaped) profile. The housing 110 includes a circumferential wall 114, the circumferential wall 114 forms an accommodating recess 112. The housing 110 further includes a plurality of fins radially extended from the circumferential wall 114 and physically connected thereon, and in this embodiment, the fins 116 are integrally-formed on the circumferential wall 114. An inner surface 115 of the circumferential wall 114 has at least at least an aligning post 117, at least a slot 118 and at least a slotting part 119.

The illuminant element 120 includes a circuit board 122, at least a light emitting diode (LED) 124 and a controlling circuit chip 126. The circuit board 122 has an aligning slot 123. The circuit board 122 is disposed on the accommodating recess 112 and the aligning post 117 is aligned with the aligning slot 123 to prevent the circuit board 122 from displacement. The circuit board 122 is provided with conductive traces (not shown) and soldering pads (not shown) to mount the LED 124. In this embodiment, the circuit board 122 is, but not limited to, a metal core printed circuit board (MCPCB) having good thermal conductivity, which can quickly remove heat produced by the LED 124.

The LED 124 is mounted on the circuit board 122 and electrically connected thereto. The LED 124 may be an alternating current (AC) LED which can directly drive by AC power source, for example AC 110V, or the LED 124 may be direct current (DC) driving LED. The DC driving LED is electrically connected to an AC to DC conversion circuit (not shown), which is electrically connected to an external AC power source. The AC power source may be AC 110V mentioned above. The AC to DC converter convers AC power source into DC power source and drives the DC driving LED. It should be noted that the AC110V is used for demonstration and is not limitation of the claim scope of the present invention, and the power source may be other appropriate AC or DC power source, such as AC220V. The controlling circuit chip 126 is mounted on the circuit board 112 and electrically connected to the LED 124 to control the operating state of the LED 124, for example, turn-on or turn-off.

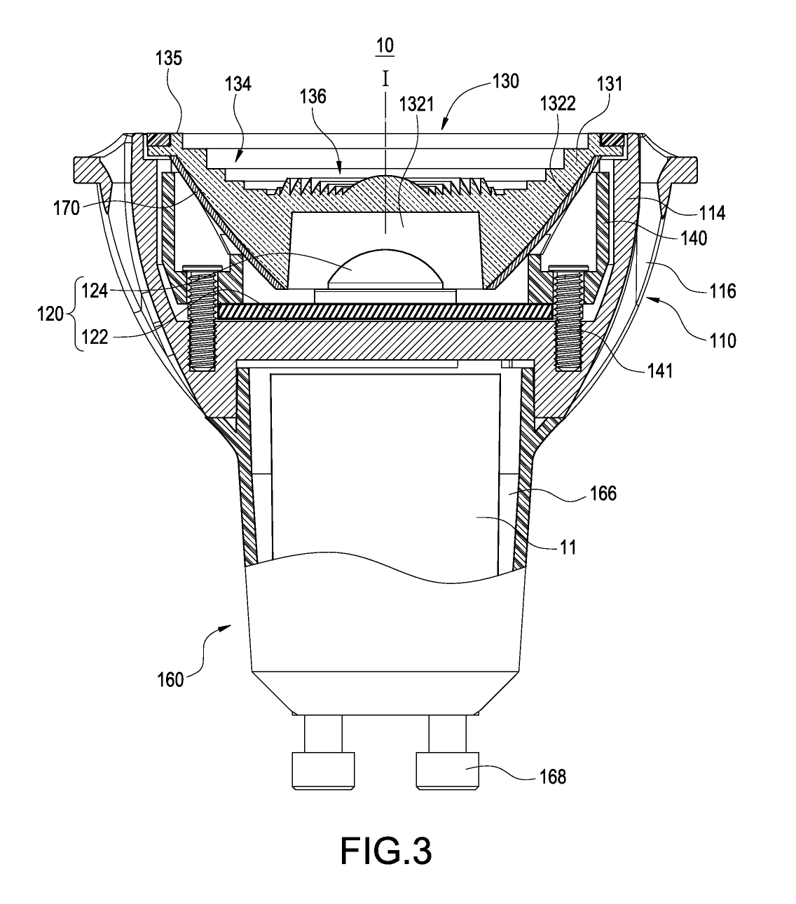

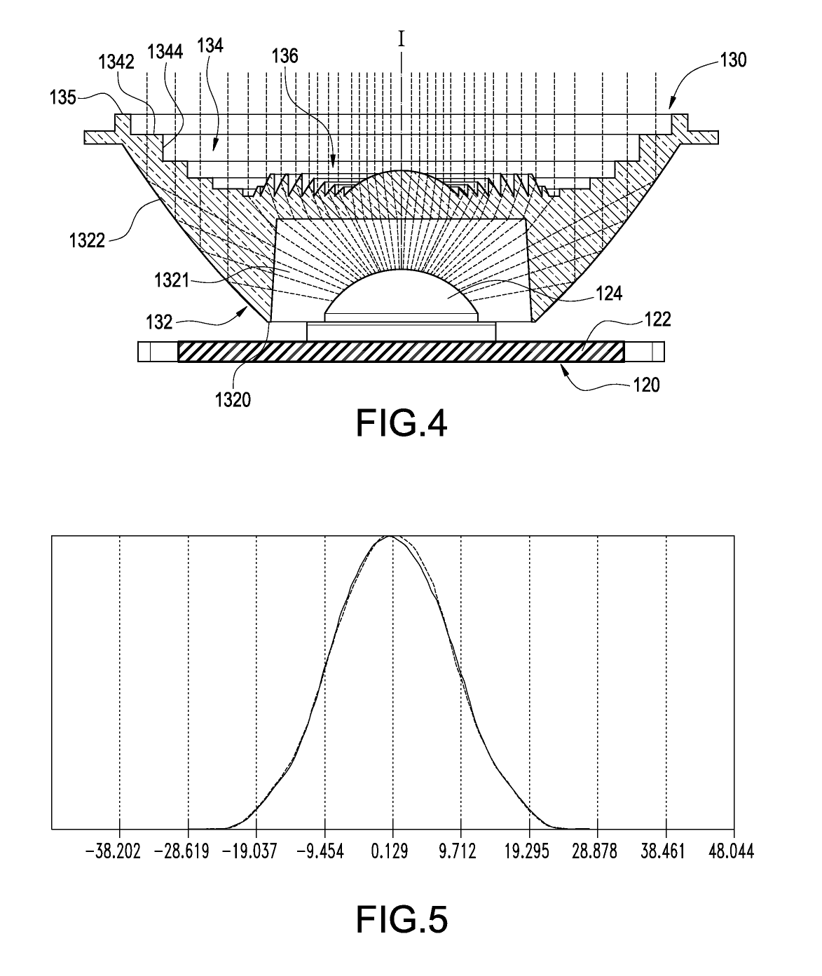

Reference is made to FIG. 3 and FIG. 4, FIG. 3 is a partially sectional view of the illuminant device according to the first embodiment of the present invention, and FIG. 4 is a sectional view of an optical lens according to a first embodiment of the present invention and shows ray tracing thereof. The optical lens 130 is disposed on the illuminant unit 120 and light emitted by the LED 124 travels to the optical lens 130, and the optical lens 130 changes the light intensity distribution of light passing therethrough.

The optical lens 130 has an optical axis I. In general, the optical axis I is a central axis of an optical system having symmetry. The optical lens 130 has a permeable main body 131 made of light permeable material, such as glass or plastic. The main body 131 has a light-incident part 132, a first light-emitting part 134 and a second light-emitting part 136. The light-incident part 132 has a bottom surface 1320 and a reflecting surface 1322.

The bottom surface 1320 has a recess 1321, the LED 124 is disposed on the recess 1321 and emits light to the optical lens 130. The reflecting surface 1322 is physically connected to the bottom surface 1320 and the first light-emitting part 134 and the distance located between the reflecting surface 1322 and the optical axis I is increased when the reflecting surface 1322 is gradually far away from the bottom surface 1320.

The first light-emitting part 134 is physically connected to the reflecting surface 1322 and has a top surface 135. The top surface 135 is gradually close to the optical axis I when the top surface 135 is gradually close to the bottom surface 1320. The top surface 135 includes a plurality of first light-emitting surfaces 1342 and second light-emitting surfaces 1344 arranged in interlaced manner. In this embodiment, the first light-emitting surfaces 1342 are substantially parallel to the bottom surface 1320 and the second light-emitting surfaces 1344 are substantially perpendicular to the bottom surface 1320 so that the first light-emitting part 134 has stepwise shape. Moreover, the length of the second light-emitting surfaces 1344 perpendicular to the bottom surface 1320 are progressively decreased when the second light-emitting surfaces 1344 are gradually close to the optical axis I. Therefore, the distance the light transmitting to the first light-emitting part 134 can be decreased to lower the losses of light transmitting inner the optical lens 130 and can further reduce the thickness and weight of the optical lens. The second light-emitting part 136 is physically connected to the top surface 135 and substantially located above the recess 1321. The second light-emitting part 136 is a Fresnel lens, and the second light-emitting part 136 may have the function of light-convergence or light-divergence. In this embodiment, the second light-emitting part 136 and the first light-emitting part 134 are integrally-formed.

With reference again to FIG. 4, the LED 124 is disposed on the recess 1321 and emits light to the optical lens 130. Part of light emitted from the LED 124 transmits to reflecting surface 1322 of the optical lens 130 and reflects with a condition of total internal reflection (TIR), which changes travelling route of light and light emitting by the first light-emitting part 134, and part is refracted by the second light-emitting part 136. The luminous intensity distribution of light passing through the optical lens 130 is shown in FIG. 5, and light distributes at both side of the optical axis I (0 degree) for 20 degrees are shown.

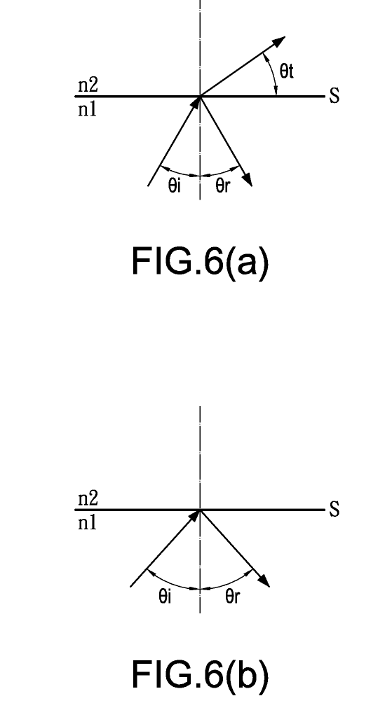

In general, a beam incident on a first medium n1 with a first refractive index to a second medium n2 with a second refractive index, part of the light is reflected into the first medium n1 at an interface S and part refracted, as shown in FIG. 6(a). In this embodiment, the second refractive index is larger than the first refractive index. In order to satisfy Law of Refraction, as known as Snell's Law, the angle-of-reflection θr will equal the angle-of-incidence θi and the angle-of-refraction θt will larger than the angle-of-incidence θi.

However, when the first refractive index of the first medium n1 is larger than the second refractive index of second medium n2 and the angle-of-incidence θi is equal to or larger than a critical angle, all the incoming ray is reflected back into the first medium n1 in the process known as total internal reflection, as shown in FIG. 6(b).

With reference again to FIG. 4, part of light emitted from the LED 124 and incident to the optical lens 130 travels to the reflecting surface 1322 and the light reflected to the first light-emitting part 134 by total internal reflection because the refractive index of the optical lens 130 is larger than the refractive index of air and the distance located between the reflecting surface 1322 and the optical axis I is increased when the reflecting surface 1322 is far away from the bottom surface 1320. Therefore, the total internal reflection occurs on the reflecting surface 1322, light changes travelling route and emits from the first light-emitting part.

With reference again to FIG. 1 and FIG. 3, the supporting element 140 is located between the optical lens 130 and the housing 110 and screwed to the housing 110 through multiple screws 141 for fastening the supporting element 140 on the housing 110 and supporting the circuit board 122 and the optical lens 130 is located above the LED 124. In this embodiment, there are two screws 141 for fastening the supporting element 140. The supporting element 140 includes a plurality of engaging part 142 and at least an aligning member 144, the aligning member 144 is aligned with the slot 118 to prevent the supporting element 140 from displacement.

The wedging element 150 includes a plurality of tenons 152. The wedging element 150 is aligned with the slotting part 119 and disposed on the optical lens 130, and the tenons 152 are engaged with the engaging part 142 such that the optical lens 130 is located within the supporting element 140 and the recess 1321 covers the LED 124.

The conductive connector 160 is engaged with the housing 110 opposite the side where the optical lens 130 is disposed. The conductive connector 160 includes a shell 162, the shell 162 has an opening end 164, a closing end 165, an accommodating space 166 and two connecting pins 168. The opening end 164 is engaged with the housing 110, the accommodating space 166 for a driving circuit board 11 is located between the opening end 164 and the closing end 166, the driving circuit board 11 is electrically connected to the illuminant unit 120. The driving circuit board 11 may include the AC to DC converting circuit mentioned above and convers AC power source into DC power source and driving the DC LED. The connecting pins 168 are protruding outwardly from the closing end 165 to electrically connect to the driving circuit board 11. In this embodiment, the conductive connector 160 is GU10 connector.

The illuminant device 10 further includes a reflecting element 170, which is located between the optical lens 130 and the supporting element 140. The reflecting element 170 is used for reflecting light passing through the reflecting surface 1322 so as to improve the light-emitting efficiency of the first light-emitting part 134 and the second light-emitting part 136.

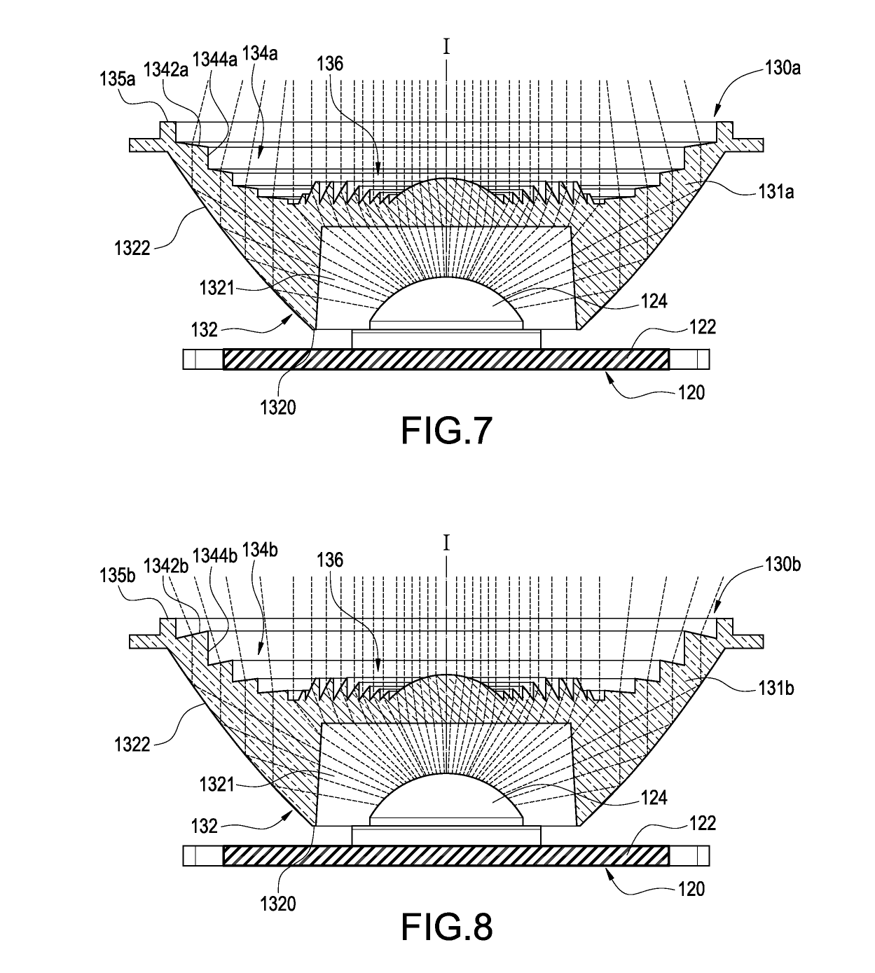

Moreover, changing the tilted angle located between a plane perpendicular to the optical axis I and the first light-emitting surface 1342 of the first light emitting part 134 of the optical lens 130 can effectively control travelling route of light emitted from the LED 124. Reference is made to FIG. 7, which is a sectional view of an optical lens according to a second embodiment of the present invention and shows ray tracing thereof. The optical lens 130a having an optical axis I includes a permeable main body 131a. The main body 131a has a light-incident part 132, a first light-emitting part 134a and a second light-emitting part 136. The light-incident part 132 has a bottom surface 1320 and a reflecting surface 1322. The bottom surface 1320 has a recess 1321. The reflecting surface 1322 is physically connected to the bottom surface 1320 and the first light-emitting part 134a and the distance located between the reflecting surface 1322 and the optical axis I is increased when the reflecting surface 1322 is gradually far away from the bottom surface 1320. The LED 124 is disposed on the recess 1321 and emits light to the optical lens 130.

The first light-emitting part 134a is physically connected to the reflecting surface 1322 and has a top surface 135a. The top surface 135a is progressively close to the bottom surface 1320 when the top surface 135a is close to the optical axis I. The top surface 135a includes a plurality of first light-emitting surfaces 1342a and second light-emitting surfaces 1344a arranged in interlaced manner. The first light-emitting surfaces 1342a are tilted with respect to a plane perpendicular to optical axis I at an angle, and the second light-emitting surfaces 1344a are substantially perpendicular to the bottom surface 1320. In this embodiment, the first light-emitting surfaces 1342a are tilted to the optical axis I with the angle. Moreover, the lengths of the second light-emitting surfaces 1344a perpendicular to the bottom surface 1320 are progressively decreased when the second light-emitting surfaces 1344a are gradually close to the optical axis I, so as the light passing through the first light-emitting part 134a is converged toward to the optical axis I. The second light-emitting part 135 is physically connected to the top surface 135a and substantially located above the recess 1321. The second light-emitting part 136 is a Fresnel lens, and in this embodiment, the second light-emitting part 136 and the first light-emitting part 134a are, but not limited to, integrally-formed.

Reference is made to FIG. 8, which is a sectional view of an optical lens according to a third embodiment of the present invention and shows ray tracing thereof. The optical lens 130b having an optical lens I includes a permeable main body 131b. The main body 131b has a light-incident part 132, a first light-emitting part 134b and a second light-emitting part 136. The light-incident part 123 has a bottom surface 1320 and a reflecting surface 1322. The bottom surface 1320 has a recess 1321 and at least a LED 124 is disposed on the recess 1321 to emit light to the optical lens 130.

The reflecting surface 1322 is physically connected to the bottom surface 1320 and the first light-emitting part 134b, and the distance located between the reflecting surface 1322 and the optical axis I is increased when the reflecting surface 1322 is gradually far away from the bottom surface 1320. The first light-emitting part 124b is physically connected to the reflecting surface 1322 and has a top surface 135b. The top surface 135b is progressively close to the bottom surface 1320 when the top surface 135b is close to the optical axis I. The top surface 135b includes a plurality of first light-emitting surfaces 1342b and second light-emitting surfaces 1344b arranged in interlaced manner. The first light-emitting surfaces 1342b are tilted with respect to a plane perpendicular to optical axis I at an angle, and the second light-emitting surfaces 1344b are substantially perpendicular to the bottom surface 1320. In this embodiment, the first light-emitting surfaces 1342b are tilted opposite to the optical axis I with the angle. Moreover, the lengths of the second light-emitting surfaces 1344b perpendicular to the bottom surface 1320 are progressively decreased when the second light-emitting surfaces 1344b are gradually close to the optical axis I, such that the light passing through the first light-emitting part 134b is diverged outwardly to the optical axis I. The second light-emitting part 135 is physically connected to the top surface 135b and substantially located above the recess 1321. The second light-emitting part 136 is a Fresnel lens, and in this embodiment, the second light-emitting part 136 and the first light-emitting part 134b are, but not limited to, integrally-formed.

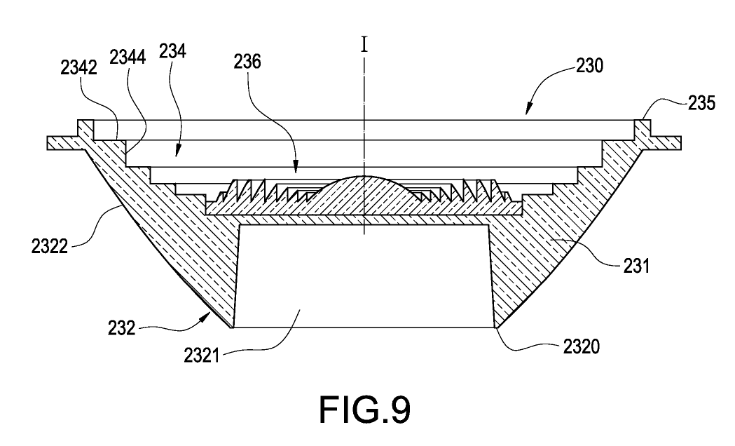

Reference is made to FIG. 9, which is a sectional view of an optical lens according to a forth preferred embodiment of the present invention. The optical lens 230 having an optical axis I includes a permeable main body 231. The main body 231 includes a light-incident part 232, a first light-emitting part 234 and a second light-emitting part 236. The light-incident part 232 has a bottom surface 2320 and a reflecting surface 2322. The bottom surface 2320 has a recess 2321. The reflecting surface 2322 is physically connected to the bottom surface 2320 and the first light-emitting part 234, and the distance located between the reflecting surface 2322 and the optical axis I is gradually increased when the reflecting surface 2322 is gradually close to the bottom surface 2320. The first light-emitting part 234 is physically connected to the reflecting surface 2322 and having a top surface 235. The top surface 235 is gradually close to the bottom surface 2320 when the top surface 235 is gradually close to the optical axis I. The top surface 235 includes a plurality of first light-emitting surfaces 2342 and second light-emitting surfaces 2344 arranged in interlaced manner. In this embodiment, the first light-emitting surfaces 2342 are substantially parallel to the bottom surface 2321 and the second light-emitting surfaces are substantially perpendicular to the bottom surface 2321 so as the first light-emitting part 234 has stepwise shape. Moreover, the lengths of the second light-emitting surfaces 2344 perpendicular to the bottom surface 2320 are decreased progressively when the second light-emitting surfaces 2344 are gradually close to the optical axis I. However, in the practical application, the first light-emitting surface 2342 may tilt with respect to a plane perpendicular to optical axis I at an angle to change the light-emitting angle, its action and related description are the same as mentioned in the second and third embodiment, and the detail thereof is not described here for brevity. The second light-emitting part 236 is a Fresnel lens and may converge light or diverge light passing therethrough. In this embodiment, the second light-emitting part 236 is disposed on the first light-emitting part 234.

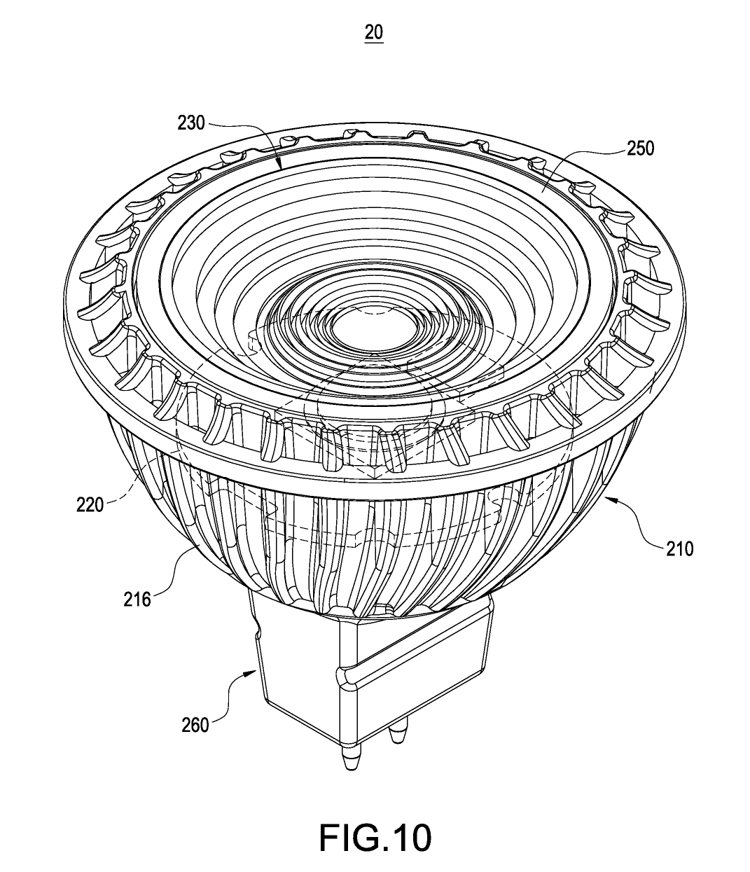

Reference us made to FIG. 10, which is an assemble view of an illuminant device according to the second embodiment of the present invention. The illuminant device 20 of this embodiment is similar to the first embodiment mentioned above. The difference is that a conductive connector 260 is MR16 connector and is adapted into socket of GU5.3 or GX5.3. However, the sockets mentioned above are used for demonstration and is not limitation of the claim scope of the present invention.

The conductive connector 260 is engaged with a housing 210 including multiple fins 216 and disposed at the opposite side the optical lens 230 disposed. The optical lens 230 is fastened on an illuminant unit 220 by a wedging element 250.

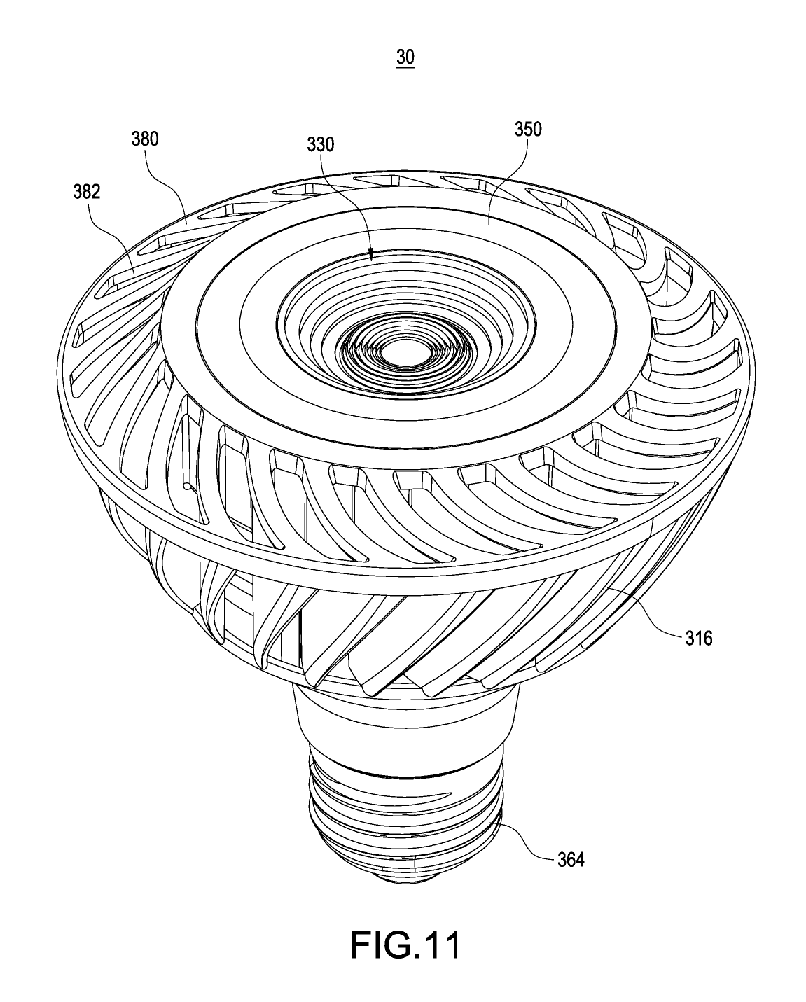

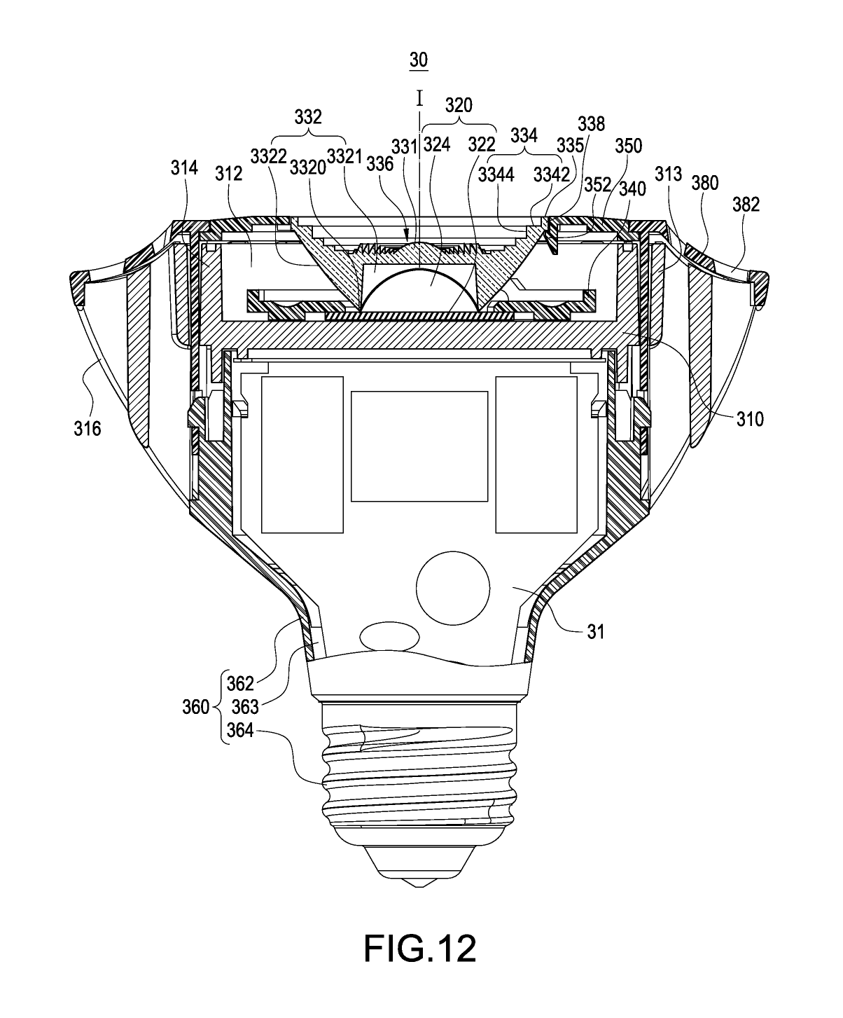

Reference is made to FIG. 11 and FIG. 12, which are respectively a perspective view and a sectional view of an illuminant device according to a third preferred embodiment of the present invention. The illuminant device 30 includes a housing 310, an illuminant unit 320, an optical lens 330, a supporting element 340, a wedging element 350, a conductive connector 360 and a metallic ring 380.

The housing 310 includes a circumferential wall 314 and the circumferential wall 314 forms an accommodating recess 312. The housing 320 further includes a plurality of slots 313 and multiple fins 316 engaged with the slots 313.

The illuminant unit 320 is disposed on the accommodating recess 312. The illuminant unit 320 includes a circuit board 322 and at least a LED 324. The circuit board 322 is, for example, a metal core printed circuit board and is provided with conductive traces (not shown) and soldering pads (not shown) to mount the LED 324. The LED 324 is mounted on the circuit board 332 and electrically connected thereon. In this embodiment, the LED 324 may be AC LED directly driven by AC power source, such as AC 110V, or the LED 324 may be a DC driving LED. The DC driving LED is electrically connected to an AC to DC conversion circuit (not shown), which is electrically connected to an external AC power source. The AC power source may be AC 110V mentioned above. The AC to DC converter convers AC power source into DC power source and drives the DC driving LED. It should be noted that the AC110V is used for demonstration and is not limitation of the claim scope of the present invention, and the power source may be other appropriate AC or DC power source, such as AC220V.

The optical lens 330 having an optical axis I includes a permeable main body 331. The optical lens 331 includes a light-incident part 332, a first light-emitting part 334 and a second light-emitting part 336. The light-incident part 332 has a bottom surface 3320 and a reflecting surface 3322. The bottom surface 3320 has a recess 3321, the reflecting surface 3322 is physically connected to the bottom surface 3320 and the distance located between the reflecting surface 3322 and the optical axis I is increased when the reflecting surface 3322 is gradually far away from the bottom surface 3320. The first light-emitting part 334 is physically connected to the reflecting surface 3322 and has a top surface 335. The top surface 335 includes a plurality of first light-emitting surfaces 3342 and second light-emitting surfaces 3344 arranged in interlaced manner. In this embodiment, the first light-emitting surfaces 3342 are substantially parallel to the bottom surface 3320 and the second light-emitting surfaces 3344 are substantially perpendicular to the bottom surface 3320 so as the first light-emitting part 334 has stepwise shape. Moreover, the lengths of the second light-emitting surfaces 3344 perpendicular to the bottom surface 3320 are progressively decreased when the second light-emitting surfaces 3344 are gradually close to the optical axis I. However, in the practical application, the first light-emitting surfaces 3342 may tilt with respect to a plane perpendicular to optical axis I at an angle to change the light-emitting angle, its action and related description are the same as mentioned in the second and third embodiment, and the detail thereof is not described here for brevity. The second light-emitting part 336 is physically connected to the top surface 335 and substantially located above the recess 3321. The second light-emitting part 336 is a Fresnel lens, and in this embodiment, the second light-emitting part 336 and the first light-emitting part 334 are, but not limited to, integrally-formed.

The supporting element 340 is disposed on the accommodating recess 312 for fixing the circuit board 322 and supporting the optical lens 330 above the LED 324.

The wedging element 350 includes a plurality of tenons 352, the tenons 352 are engaged with an engaging part 338 of the optical lens 330 to fasten the optical lens 330.

The conductive connector 360 is engaged with the housing 310 opposite the side where the optical lens 330 is disposed. The conductive connector 360 includes a shell 162 and a connecting part 364. The shell 362 has an accommodating space 363, and a driving circuit board 31 is located inner the accommodating space 363. The driving circuit board 31 is electrically connected to the illuminant unit 320, and when the LED 324 is a DC driving LED, the driving circuit board 31 may include the AC to DC converting circuit mentioned above and convers AC power source into DC power source and driving the DC LED. The connecting part 364 is electrically connected to the driving circuit board 31 and the driving circuit board 31 is electrically connected to the illuminant unit 320. In this embodiment, the conductive connector 360 is E26 or E27 connector.

The metallic ring 380 is engaged with the top of the fins 316 and has multiple ventilating holes 382 to improve heat dissipation effect to the LED 324 and prevent user from injuring by the sharp limbs of the fins 316.

The illuminant device 30 may further includes a reflecting element located between the optical lens 330 and the supporting element 34. The reflecting element is used for reflecting light passing through the reflecting surface 3322 so as to improve the light-emitting efficiency of the first light-emitting part 334 and the second light-emitting part 336.

To sum up, in the present invention, main body of the optical lens has reflecting surface can directly change the travelling route of light so as to emit light by the first light-emitting part, and the first light-emitting part is designed to be stepwise can effectively reduce the transmission distance of light travelling in the main body to reduce losses of light travelling in the main body and simultaneously reduce volume and weight of the optical lens.

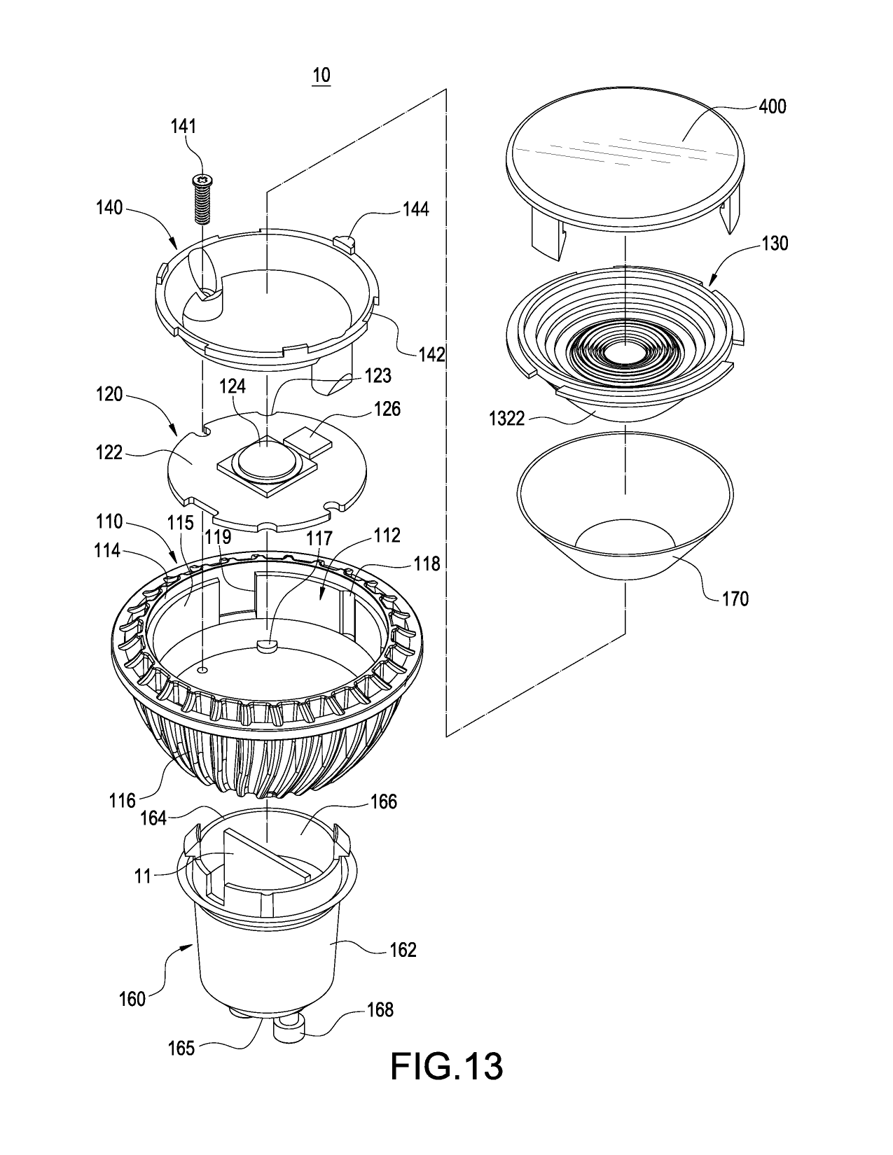

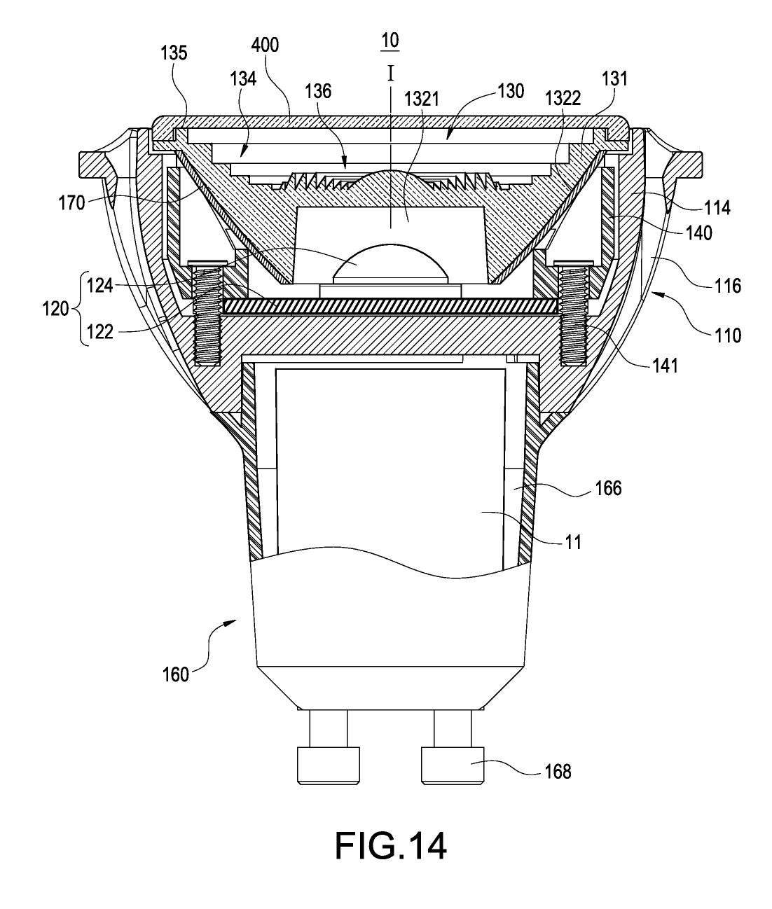

It should be noted that the illuminant device 10, 20, 30 may further include a diffusing element 400, as shown in FIG. 13 and FIG. 14 to improve the uniformity of light, namely, a diffusing plate with a characteristic of light-divergence may be disposed on the optical lens 130 130a, 130b, 230, 330 to diverge light emitted from the LED 124, 324 and can obtain an optimal flare quality. In the FIG. 13 and FIG. 14, the illuminant element is, but not limited to, the same as the illuminant element of the first embodiment. The diffusing element 400 is disposed on the optical lens and opposite to a side where the LED 124 is disposed for diffusing light provided by the LED and to obtain optimal flare quality.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. An optical lens having an optical axis, the optical lens comprising:
a main body, comprising:
a light-incident part having a bottom surface and a reflecting surface, the bottom surface having a recess, the reflecting surface physically connected to the bottom surface and the distance located between the reflecting surface and the optical axis is increased when the reflecting surface is gradually far away from the bottom surface;
a first light-emitting part physically connected to the reflecting surface, the first light-emitting surface having a top surface and the top surface gradually close to the bottom surface when the top surface is gradually close to the optical axis;
a second light-emitting part physically connected to the top surface and substantially located above the recess.

2. The optical lens in claim 1, wherein the second light-emitting part is a Fresnel lens.

3. The optical lens in claim 1, wherein the top surface comprises a plurality of first light-emitting surfaces and second light-emitting surfaces arranged in interlaced manner.

4. The optical lens in claim 3, wherein the second light-emitting surfaces are substantially perpendicular to the bottom surface, the first light-emitting surfaces are substantially parallel to the bottom surface and the first light-emitting part is stepwise.

5. The optical lens in claim 4, wherein lengths of the second light-emitting surfaces perpendicular to the bottom surface are progressively decreased when the second light-emitting surfaces are gradually close to the optical axis.

6. The optical lens in claim 3, where in the first light-emitting surfaces are tilted with respect to a plane perpendicular to the optical axis at an angle, the second light-emitting surfaces are substantially perpendicular to the bottom surface and the lengths of the second light-emitting surfaces perpendicular to the bottom surface are progressively decreased when the second light-emitting surfaces are close to the optical axis.

7. The optical lens in claim 1, where in the first light-emitting part and the second light-emitting part are integrally-formed.

8. An illuminant device, comprising:
a housing having a circumferential wall and the circumferential wall formed an accommodating recess;
an illuminant unit disposed on the accommodating recess and comprising a circuit board and at least a light emitting diode (LED), the circuit board disposed on the accommodating recess and the LED mounted on the circuit board;
an optical lens having an optical axis, the optical lens comprising:
a main body, comprising:
a light-incident part comprising a bottom surface and a reflecting surface, the bottom surface having a recess, the reflecting surface physically connected to the bottom surface and the distance located between the reflecting surface and the optical axis gradually increased when the reflecting surface is far away from the bottom surface, the LED being disposed on the recess;
a first light-emitting part physically connected to the reflecting surface and having a top surface, the top surface gradually close to the bottom surface when the top surface is gradually close to the optical axis;
a second light-emitting part physically connected to the top surface and substantially located above the recess; and
a conductive connector engaged with the housing and opposite to a side where the optical lens is disposed.

9. The illuminant device in claim 8, wherein the second light-emitting part is a Fresnel lens.

10. The illuminant device in claim 8, wherein the top surface comprises a plurality of first light-emitting surfaces and second light-emitting surfaces arranged in interlaced manner.

11. The illuminant device in claim 10, wherein the second light-emitting surfaces are substantially perpendicular to the bottom surface, the first light-emitting surfaces are substantially parallel to the bottom surface and the first light-emitting part is stepwise.

12. The illuminant device in claim 11, wherein the length of second light-emitting surfaces perpendicular to the bottom surface are progressively decreased when the second light-emitting surfaces are gradually close to the optical axis.

13. The illuminant device in claim 10, wherein the first light-emitting surfaces are tilted with respect to a plane perpendicular to the optical axis at an angle, the second light-emitting surfaces are substantially perpendicular to the bottom surface and the length of the second light-emitting surfaces perpendicular to the bottom surface are progressively decreased when the second light-emitting surfaces are gradually close to the optical axis.

14. The illuminant device in claim 8, wherein the first light-emitting part and the second light-emitting part are integrally-formed.

15. The illuminant device in claim 8, further comprises a reflecting element located between the housing and the optical lens.

16. The illuminant device in claim 8, wherein the circumferential wall has an inner surface, the inner surface has at least an aligning post and at least a slot, the aligning post is aligned to at least an aligning recess of the circuit board, at least an aligning member of the supporting element is aligned the slot.

17. The illuminant device in claim 8, wherein the housing further comprises multiple fins radially extended from the circumferential wall and electrically connected thereon.

18. The illuminant device in claim 8, further comprises a supporting element located between the housing and the optical lens and supporting the optical lens.

19. The illuminant device in claim 18, further comprises a reflecting element located between the optical lens and the supporting element.

20. The illuminant device in claim 18, further comprises a wedging element, the wedging element has at least a tenon, the tenon is aligned with the slot part of an inner surface of the circumferential wall and engaged with at least an engaging part of the supporting element through the optical lens.

21. The illuminant device in claim 8, wherein the conductive connector is GU10 connector, MR16 connector, E26 connector or E27 connector.

22. The illuminant device in claim 18, further comprises a plurality of screws, the screws protruding outwardly from the supporting element and screw into the housing for fastening the supporting element on the housing.

23. The illuminant device in claim 8, further comprises a wedging element, the wedging element has a plurality of tenons, the tenons are engaged with an engaging part of the optical lens.

24. The illuminant device in claim 8, wherein the conductive connector comprising:
a shell, comprising:
an opening end;
a closing end opposite to the opening end;
an accommodating space for disposing a driving circuit board; and
two connecting pins protruding outwardly from the closing end and electrically connected to the driving circuit board.

25. The illuminant device in claim 8, further comprises a diffusing element disposed on one side opposite the LED disposed of the optical lens.
